(19) United States
(12) Patent Application Publication
(10) Pub. No.: US 2026/0167095 A1
(43) Pub. Date: Jun. 18, 2026

(54) VEHICLE AND CONTROL METHOD THEREOF

(71) Applicants: HYUNDAI MOTOR COMPANY, SEOUL (KR); KIA CORPORATION, SEOUL (KR)

(72) Inventors: Tae Woo Lee, Hwaseong-si (KR); Yoo Jung Han, Hwaseong-si (KR); Hyo Jun Kwak, Hwaseong-si (KR); Kyung Min Ryu, Hwaseong-si (KR); Chan Yang Han, Hwaseong-si (KR); Jun Ho Jo, Hwaseong-si (KR); Hee Jin Lee, Hwaseong-si (KR); Byung Gil Kim, Hwaseong-si (KR)

(73) Assignees: HYUNDAI MOTOR COMPANY, SEOUL (KR); KIA CORPORATION, SEOUL (KR)

(21) Appl. No.: 19/405,190

(22) Filed: Dec. 1, 2025

(30) Foreign Application Priority Data
Dec. 16, 2024 (KR) 10-2024-0187165

(51) Int. Cl. B60Q 1/44

(52) U.S. Cl. CPC B60Q 1/44

(57) ABSTRACT

A vehicle includes: a brake indicator; a sensor unit configured to detect state information of the vehicle and an acceleration signal of the vehicle; an acceleration correction unit configured to generate a corrected acceleration from the acceleration signal of the vehicle; and a control unit configured to control the brake indicator based on a value of the corrected acceleration. The acceleration correction unit sets effective ranges of an acceleration and an acceleration variation of the vehicle and generates the corrected acceleration within the effective ranges.

### CROSS-REFERENCE TO RELATED APPLICATION

This application claims priority to and the benefit of Korean Patent Application No. 10-2024-0187165, filed on Dec. 16, 2024, the disclosure of which is incorporated herein by reference in its entirety.

### BACKGROUND

### 1. Technical Field

Various embodiments of the present disclosure relate to a vehicle including a brake indicator and a control method thereof.

### 2. Discussion of Related Art

A brake indicator can be provided on a vehicle to indicate a braking state of the vehicle that is traveling. For example, tail lights of a vehicle may be turned on in conjunction with the operation of a brake of the vehicle. Whether a vehicle is decelerating can be determined by a following vehicle through a method that detects the activation of the tail lights of the decelerating vehicle when the brakes are applied.

In the case of electric vehicles driven by an electric motor, a regenerative braking technology is being introduced. The electric driving motor can be manufactured to rotate in both directions. When the driving motor accelerates the vehicle, the electric energy stored in a battery is converted into the kinetic energy of the motor. The driving motor can rotate in a forward direction to accelerate the vehicle.

When a driver steps off an accelerator pedal, i.e., when a driving force of the vehicle is weakened, the driving motor rotates in the forward direction, and regenerative torque which applies resistance in a direction opposite to the driving motor can act. When the regenerative torque acts, the driving motor receives resistance in a reversely rotating direction, and the vehicle can be decelerated. As the vehicle decelerates, the kinetic energy of the driving motor can be converted into electrical energy and stored in the battery.

In other words, there is an advantage that some energy lost in a traveling vehicle can be recycled through regenerative braking technologies.

In the case of regenerative braking, since the vehicle decelerates similar to braking through a general braking device such as a brake, it is necessary to operate a brake indicator. When the deceleration of the vehicle is a predetermined level or more, the brake indicator needs to be operated. The vehicle can determine whether to activate the brake indicator based on deceleration calculated by an airbag control unit (ACU). However, there is a concern that a signal of the calculated deceleration may be distorted due to external factors of the vehicle, thereby causing unnecessary blinking of the brake indicator. These external factors of the vehicle include high-speed air resistance, obstacles on a road surface, and the like. In addition, there is a challenge in that an operation logic of the brake indicator needs to be set individually based on a traveling mode of the vehicle.

### SUMMARY

The present disclosure is directed to setting a corrected acceleration as an operation reference for a brake indicator by filtering out the effects of external disturbances through acceleration and acceleration variation.

Objects of the present disclosure are not limited to the above-described objects, and other objects that are not described should be clearly understood by those having ordinary skill in the art from the following description.

A vehicle according to various embodiments of the present disclosure includes: a brake indicator; a sensor unit configured to detect state information of the vehicle and an acceleration signal of the vehicle; an acceleration correction unit configured to generate a corrected acceleration from the acceleration signal of the vehicle; and a control unit configured to control the brake indicator based on a value of the corrected acceleration.

In some embodiments, the acceleration correction unit may set effective ranges of an acceleration and an acceleration variation of the vehicle and generate the corrected acceleration within the effective ranges.

In some embodiments, the acceleration correction unit may calculate a maximum value and a minimum value of the acceleration, defining the effective range of the acceleration. The minimum value of the acceleration may be calculated based on the state information of the vehicle.

In some embodiments, the state information of the vehicle may include a regenerative torque, a driving load, and a braking torque.

In some embodiments, the acceleration correction unit may calculate a maximum value of the acceleration variation and a minimum value of the acceleration variation, defining the effective range of the acceleration variation.

In some embodiments, the sensor unit may detect a motor torque of the vehicle. The maximum value of the acceleration variation and the minimum value of the acceleration variation may be calculated by differentiating the motor torque.

In some embodiments, the acceleration correction unit may calculate a delay time including a sensing delay time generated by the sensor unit and a calculation delay time of the acceleration correction unit and calculate an offset for adjusting the corrected acceleration in response to the delay time. The offset may be proportional to a differential value of the motor torque.

In some embodiments, the control unit may operate the brake indicator when the corrected acceleration value is a preset operation reference or more.

In some embodiments, the sensor unit may detect a desired torque of the vehicle. The control unit may operate the brake indicator when the corrected acceleration value is the preset operation reference or more and a direction of the desired torque and a direction of the corrected acceleration are the same.

A control method according to an embodiment of the present disclosure includes:
receiving an acceleration of a vehicle; setting an effective range of the acceleration of the vehicle; setting an effective range of an acceleration variation of the vehicle; generating a corrected acceleration within the effective ranges; and controlling a brake indicator based on a value of the corrected acceleration.

In some embodiments, the setting of the effective range of the acceleration of the vehicle may include receiving state information of the vehicle, and calculating a maximum value and a minimum value of the acceleration based on the state information of the vehicle.

In some embodiments, the state information of the vehicle may include a regenerative torque, a driving load, and a braking torque of the vehicle.

In some embodiments, the setting of the effective range of the acceleration variation may include: receiving a motor torque of the vehicle, differentiating the motor torque to calculate a motor torque variation, and calculating a maximum value and a minimum value of the acceleration variation.

In some embodiments, the control method may further include calculating an offset based on a delay time after the setting of the effective range of the acceleration variation. The offset may be proportional to a motor torque variation.

In some embodiments, the controlling of the brake indicator based on the corrected acceleration value may include comparing an operation reference of the brake indicator with the value of the corrected acceleration.

In some embodiments, the controlling of the brake indicator based on the corrected acceleration value may further include comparing the corrected acceleration value with the desired torque. The brake indicator may be operated when the corrected acceleration value and the desired torque are the same direction.

### BRIEF DESCRIPTION OF THE DRAWINGS

The above and other objects, features, and advantages of the present disclosure should be more clearly understood by those having ordinary skill in the art from the following detailed description when taken in conjunction with the accompanying drawings, in which:

FIG. 1 illustrates a vehicle communicating with another device to transmit and receive data according to an embodiment of the present disclosure;

FIG. 2 illustrates modules for a vehicle according to an embodiment of the present disclosure;

FIG. 3 illustrates a brake indicator and a configuration of controlling the brake indicator according to an embodiment of the present disclosure;

FIG. 4 is a flowchart illustrating a method of controlling a vehicle according to an embodiment of the present disclosure;

FIG. 5 is a flowchart illustrating a method of setting an effective range of acceleration according to an embodiment of the present disclosure;

FIG. 6 is a flowchart illustrating a method of setting an effective range of an acceleration variation according to an embodiment of the present disclosure;

FIG. 7 illustrates setting of an effective range of acceleration according to an embodiment of the present disclosure;

FIG. 8 is a flowchart illustrating an order of generating a corrected acceleration according to an embodiment of the present disclosure;

FIG. 9 illustrates that an offset is calculated based on torque variation and acceleration according to an embodiment of the present disclosure; and

FIG. 10 is a flowchart illustrating a method of operating a brake indicator based on a corrected acceleration according to an embodiment of the present disclosure.

### DETAILED DESCRIPTION

Hereinafter, embodiments of the present disclosure are described in detail with reference to the accompanying drawings so that those having ordinary skill in the art to which the present disclosure pertains can easily carry out the present disclosure. However, the present disclosure may be implemented in various different forms and is not limited to embodiments described herein.

In describing embodiments of the present disclosure, when it is determined that the detailed description of known configurations or functions may obscure the gist of the present disclosure, the detailed description thereof has been omitted. In addition, components irrelevant to the description of the present disclosure have been omitted from the drawings, and similar components have been denoted as similar reference numerals.

In the present disclosure, when a certain component is described as being “connected,” “coupled,” or “joined” to another component, it may include not only a direct connection relationship, but also an indirect connection relationship in which still another component is present therebetween. In addition, when a certain component is described as “including” or “having” another component, it means further including still another component rather than precluding other components unless especially stated otherwise.

In the present disclosure, the terms “first”, “second”, and the like are used only for the purpose of distinguishing one component from another component and do not limit the order or importance of the components unless specifically stated. Accordingly, within the scope of the present disclosure, a first component in one embodiment may be referred to as a second component in another embodiment, and likewise, a second component in one embodiment may be referred to as a first component in another embodiment.

In the present disclosure, components distinguished from each other are intended to clearly describe the characteristics of each and do not mean that the components are necessarily separated. In other words, a plurality of components may be integrated and formed as a single hardware or software unit, and a single component may be distributed and formed as a plurality of hardware or software units. Accordingly, even when not mentioned separately, the embodiments in which the components are integrated or distributed are also included in the scope of the present disclosure.

In the present disclosure, components described in various embodiments do not necessarily mean essential components, and some may be optional components. Accordingly, an embodiment composed of a subset of components described in one embodiment is also included in the scope of the present disclosure. In addition, an embodiment including other components in addition to the components described in various embodiments is also included in the scope of the present disclosure.

In the present disclosure, each of the phrases such as “A or B,” “at least one of A and B,” “at least one of A or B,” “A, B, or C,” “at least one of A, B, and C,” and “at least one of A, B, C, or combination thereof” may include one of items listed together in the corresponding phrase among these phrases or all possible combinations thereof.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer readable media, as part of the apparatus.

Advantages and features of the present disclosure and methods for achieving them should become clear with reference to embodiments described below in detail together with the accompanying drawings. However, the present disclosure is not limited to the embodiments disclosed below but can be implemented in various different forms. These embodiments are merely provided to make the disclosure of the present disclosure complete and to fully inform those having ordinary skill in the art to which the present disclosure pertains of the scope of the present disclosure.

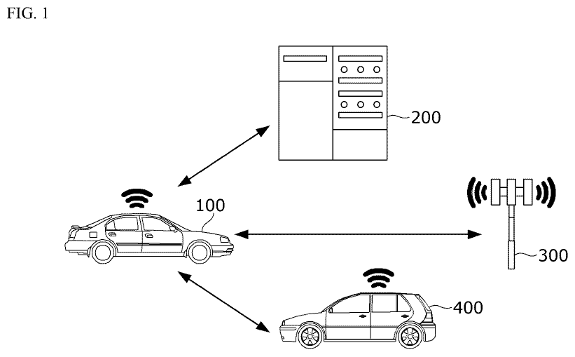

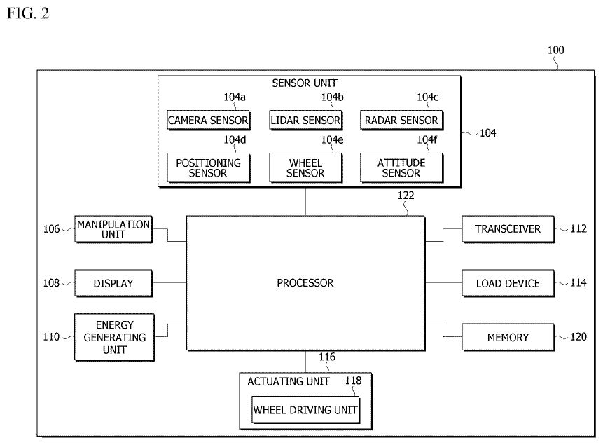

Hereinafter, a vehicle according to an embodiment of the present disclosure is described with reference to FIGS. 1 and 2. FIG. 1 illustrates a vehicle which communicates with another device to transmit and receive data.

Referring to FIG. 1, a vehicle 100 may be driven on electric energy. In the case of electric energy, the vehicle 100 may be, for example, a pure battery-based vehicle driven by only a high-voltage battery or may adopt a gas-based fuel cell as an energy source. In addition, a fuel cell may use various types of gases for generating electric energy, and the gas may be charged to the vehicle 100, e.g., in a liquefied state. The gas may be, for example, hydrogen. However, the present disclosure is not limited thereto, and various gases may be applied. As another example, the vehicle 100 may drive an actuating unit 116 selectively using an internal combustion engine based on fossil energy and the energy of an electric battery and may be a hybrid-type vehicle.

The vehicle 100 may refer to a movable device. The vehicle 100 is a ground vehicle that travels on the ground and may be a typical passenger or commercial vehicle, a purpose built vehicle (PBV), or the like. The vehicle 100 may be a four-wheeled vehicle such as a passenger car, an SUV, or a small truck. Alternatively, the vehicle 100 may be a vehicle with more than four wheels such as a bus, a large truck, a container transport vehicle, a heavy equipment vehicle, or the like. The ground vehicle may be referred to as a vehicle including not only a vehicle that moves on the ground but also a vehicle that moves underground. The vehicle 100 may be a robot in a broad sense, such as a means of transportation, and the robot may move using wheels, tracks, or other moving modules (e.g., mobility systems, mobility devices, and the like). In the present disclosure, a ground mobility device such as a ground vehicle is mainly described, but unless it contradicts the present disclosure, the present embodiment may also be applied to air mobility devices, such as an advanced air mobility (AAM), an aircraft, and the like, and water mobility devices, such as a ship, a submarine, and the like.

The vehicle 100 may communicate with other devices 200 and 300 or another vehicle 400. The other devices may include, for example, a server 200 for supporting various control, state management, and traveling of the vehicle 100; an intelligent transportation system (ITS) device 300 for receiving information from an ITS; various types of user devices; and the like. The server 200 may be, for example, an external device operated by a vehicle manufacturer or providing an autonomous driving service and may receive connected data of the vehicle 100 or transmit data desired for autonomous driving. To support autonomous driving of the vehicle 100 and various services, the server 200 may transmit various types of information and software modules that are used for controlling the vehicle 100 to the vehicle 100 in response to the request and data transmitted from the vehicle 100 and the user device.

The ITS device 300 is, for example, a road side unit (RSU) and may exchange vehicle recognition data, traveling control and state data, peripheral environmental data of a vehicle, map data, and the like with the vehicle 100 through vehicle-to-infrastructure (V2I) communication to assist a user in driving his or her vehicle or support the autonomous driving of the vehicle 100. The vehicle 100 may exchange the data listed above with another vehicle 400 through vehicle-to-vehicle (V2V) communication to support manual driving or autonomous driving.

The vehicle 100 may communicate with another vehicle or other devices based on cellular communication, wireless access in vehicular environment (WAVE) communication, dedicated short range communication (DSRC), short-range communication, or another communication method.

For example, the vehicle 100 may use a communication network such as Long Term Evolution (LTE) or 5G, a Wi-Fi communication network, a WAVE communication network, or the like as a cellular communication network to communicate with the server 200, the ITS device 300, and another vehicle 400. As another example, the DSRC or the like used in the vehicle 100 may be used for communication between vehicles. A communication method between the vehicle 100, the server 200, the ITS device 300, another vehicle 400, and the user device is not limited to the above-described embodiment.

FIG. 2 illustrates modules for a vehicle according to one embodiment of the present disclosure.

The vehicle 100 may include a sensor unit 104, a manipulation unit 106, a display 108, a load device 114, and a transceiver 112.

The sensor unit 104 may include various types of detectors for detecting various states and situations of the vehicle 100 that occur in an external environment, internal system, user manipulation, and boarding space.

Specifically, the sensor unit 104 may include an outward-facing camera 104a, a Light Detection and Ranging (LiDAR) sensor 104b, a radar sensor 104c, and the like to recognize dynamic and static objects that are present outside the vehicle 100. The camera 104a may recognize an external object as a video while used in the vehicle 100 to generate video data and transmit the video data to a processor 122. The LiDAR sensor 104b may generate point cloud data as data of the identified external object and transmit the point cloud data to the processor 122 in order to generate three-dimensional spatial information that identifies at least the shape of the external object. The radar sensor 104c may emit radio waves of a specific frequency to a peripheral area of the vehicle 100 to generate radar data through radio waves reflected from the external object in order to identify the presence of an external object, a relative distance, speed, direction, and the like. In the present disclosure, the LiDAR sensor 104b is provided as an example, but in another example, the LiDAR sensor 104b may not be mounted.

The sensor unit 104 may include a positioning sensor 104d, a wheel sensor 104e, an attitude sensor 104f, and the like to check a position, speed, traveling attitude, and the like of the vehicle. The attitude sensor 104f may include a gyro sensor, an angular velocity sensor, an acceleration sensor, and the like.

In the present disclosure, the sensors of the sensor unit 104 referred to in the description of the embodiment are mainly described, but sensors for detecting various situations, which are not listed above, may be additionally included.

The manipulation unit 106 may be configured as a module manipulated by a user for driving. For example, the manipulation unit 106 may be a steering wheel for manual driving, an automatic or manual transmission, an accelerator pedal, a brake pedal, and the like. The manipulation unit 106 may further include an interface for using, deactivating, and selecting a specific function of an autonomous driving mode requested by the user so that the user may use the autonomous driving function. To receive various requests related to autonomous driving, the manipulation unit 106 may be composed of, for example, a hard type interface provided at a predetermined position inside the vehicle 100 or a soft type interface that may be touched on the display 108. According to the specifications of the autonomous driving vehicle, at least one of the steering wheel, the transmission, and the pedals may be omitted. As another example, the manipulation unit 106 may include a module that receives a control request of the user for the load device 114 in addition to driving control.

The display 108 may serve as a user interface. The display 108 may be controlled by the processor 122 to display an operation state, control state, route/traffic information, and the remaining energy information of the vehicle 100, a content requested by the driver, and the like. In addition, the display 108 may be formed as a touch screen capable of detecting the input of the driver to receive the request of the driver that instructs the processor 122.

The load device 114 may be mounted on the vehicle 100 and may be a type of non-driving electric device not including a driving power system such as a wheel driving unit 118 or the like. The load device 114 is an auxiliary device for receiving power from the energy generation unit 110 and may be, for example, any device installed on an air conditioning system, a lighting system, a seat system, or the vehicle 100. In the present disclosure, a cooling/heating system for cooling or heating at least one of a battery, a fuel cell, an internal combustion engine, an air conditioning system, and a specific area of the vehicle 100 may be further included.

The transceiver 112 may support mutual communication with the server 200, the ITS device 300, another vehicle 400, and the like. The transceiver 112 may include, for example, a module for processing cellular communication, WAVE, DSRC communication, or the like. In the present disclosure, the transceiver 112 may transmit data generated or stored while traveling to the server 200 and receive data and a software module transmitted from the server 200. The transceiver 112 may support communication with an electronic device of an occupant inside the vehicle 100. In the present disclosure, the vehicle 100 may transmit and receive data used in the method according to the present disclosure with an external device through the transceiver 112.

In addition, the vehicle 100 may include the energy generation unit 110 and the actuating unit 116.

The energy generation unit 110 may generate and supply power and electric power that are used in a driving power system such as the actuating unit 116 and a non-driving power system. The non-driving power system may include, for example, the sensor unit 104, the manipulation unit 106, the display 108, the load device 114, the transceiver 112, and the like but is not limited thereto, and may include various components for implementing sensing, interface, communication, and convenience functions other than components directly involved in a driving operation. When the vehicle 100 is driven on electric energy, the energy generation unit 110 may be provided as, for example, an electric battery charged from the outside or provided as a combination of an electric battery and a fuel cell that charges the battery. In the case of a combination of the electric battery and the fuel cell, the energy generation unit 110 may include a tank for storing a material used to produce power of the fuel cell, for example, liquefied hydrogen. In addition, when the vehicle 100 is a hybrid type, the energy generation unit 110 may be provided as a combination of the internal combustion engine and the electric battery.

The actuating unit 116 may include at least one module that implements a driving operation and performs at least one driving operation of longitudinal control such as acceleration and deceleration and lateral control such as steering based on a user request from the manipulation unit 106. To perform the driving operation based on the manual manipulation of the user or the instruction of the processor 122 by autonomous driving, the actuating unit 116 may include the wheel driving unit 118, and a mechanical component and electronic module for implementing the driving operation of the wheel driving unit 118. When the vehicle 100 is operated on electric energy, the vehicle 100 may include an assembly for transmitting the requested driving operation to the wheel driving unit 118.

The wheel driving unit 118 may include a plurality of wheels, a driving force generation module for generating a driving force to impart the driving force to wheels or transmitting the driving force, a braking module for decelerating the driving of the wheels, a steering module for achieving transverse control of the wheels, and the like. When the vehicle 100 is driven on electric energy, the driving force generation module may be provided as a motor assembly for generating a driving force based on power output from the electric battery. The braking module of the electricity-based vehicle 100 may further have a regenerative braking function.

In addition, the vehicle 100 may include a memory 120 and the processor 122.

The memory 120 may store an application and various types of data for controlling the vehicle 100 and load the application or read or write the data in response to the request of the processor 122. In the present disclosure, the memory 120 may store the state information of the vehicle. The state information of the vehicle may be detected through the sensor unit.

The processor 122 may perform the overall control of the vehicle 100. The processor 122 may be configured to execute applications and instructions that are stored in the memory 120.

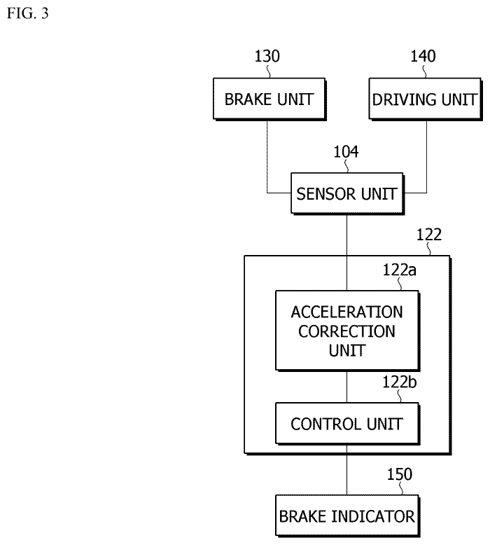

FIG. 3 illustrates a brake indicator and a configuration of controlling the brake indicator according to an embodiment.

Referring to FIG. 3, the vehicle 100 according to one embodiment of the present disclosure may include the sensor unit 104, and the processor 122 may include an acceleration correction unit 122a and a control unit 122b. In addition, the vehicle 100 may include a brake indicator 150 for indicating that braking is performed based on the deceleration of the vehicle 100.

The sensor unit 104 may detect the state information of the vehicle 100. The state information of the vehicle 100 may include information about the traveling of the vehicle 100. The state information of the vehicle 100 may include information such as a speed, an acceleration, motor torque, regenerative torque, or desired torque. The sensor unit 104 may be electrically connected to a component related to the traveling of the vehicle 100 to receive the state information of the vehicle 100.

The component related to the traveling of the vehicle 100 may be the actuating unit 116. Since the actuating unit 116 implements the traveling operation of the vehicle 100, the actuating unit 116 may include a driving unit 140 and a brake unit 130 that are related to an acceleration and deceleration of the vehicle 100.

The sensor unit 104 illustrated in FIG. 3 is illustrated as being connected to the brake unit 130 and the driving unit 140. The driving unit 140 may include a motor for providing a driving force and an accelerator pedal for controlling the acceleration of the vehicle 100. The sensor unit 104 may be connected to the driving unit 140 to receive motor torque information. Motor torque corresponds to the magnitude of torque actually applied by the motor to drive the vehicle 100. The sensor unit 104 may detect whether a driver manipulates a pedal. The magnitude of the regenerative torque may be determined based on a degree to which the pedal is manipulated and thus may be detected through a position of the pedal.

The brake unit 130 is a component for braking the vehicle 100 and may include a brake and a brake pedal. The sensor unit 104 may detect a braking torque generated by the operation of the brake pedal when the user operates the brake pedal.

The vehicle 100 according to the embodiment of the present disclosure may include the processor 122, and the processor 122 may be electrically connected to the sensor unit 104. The processor 122 may generate a corrected acceleration based on the state information of the vehicle 100 detected by the sensor unit 104. The corrected acceleration corresponds to a signal from which the influence of external disturbance is removed from an acceleration signal of the vehicle 100. The processor 122 may control the brake indicator 150 based on the corrected acceleration.

The processor 122 may include an acceleration correction unit 122a for generating the corrected acceleration, and the control unit 122b for controlling the brake indicator 150 based on the generated corrected acceleration.

The acceleration correction unit 122a corresponds to a component for processing the acceleration signal detected by the sensor unit 104. The acceleration signal may include the influence of external disturbance such as unevenness, bumps, or the like on a road surface. Acceleration change may be temporarily generated by external disturbance, and when an acceleration signal value detected by the external disturbance satisfies an operation reference of the brake indicator 150, the brake indicator 150 may operate instantaneously. It is desired to remove the influence of external disturbance to prevent the brake indicator 150 from operating instantaneously when the external disturbance occurs.

The acceleration correction unit 122a may generate an acceleration value as an actual corrected acceleration based on an actual acceleration and an acceleration variation of the vehicle 100 as is described below. The corrected acceleration may reflect a current state of the vehicle 100, which includes the traveling state of the vehicle 100, to set effective ranges of the acceleration and the acceleration variation and filter the acceleration signal due to external disturbance.

The control unit 122b controls the brake indicator 150 based on the corrected acceleration value generated by the acceleration correction unit 122a. The operation of the brake indicator 150 may be controlled based on specific operation conditions. The brake indicator 150 may be operated when the deceleration of the vehicle 100 is a predetermined level or more, i.e., when the vehicle 100 is traveling at deceleration greater than preset reference deceleration. The control unit 122b may determine whether the corrected acceleration value satisfies the operation reference of the brake indicator 150. When the corrected acceleration satisfies the operation reference of the brake indicator 150, the control unit 122b may operate the brake indicator 150.

The acceleration correction unit 122a of the processor 122 may process the acceleration signal to generate the corrected acceleration. The acceleration signal is a signal that reflects the influence of external disturbance, and the acceleration value may be changed rapidly when the external disturbance occurs. The acceleration correction unit 122a according to the embodiment of the present disclosure may set the ranges of an acceleration and an acceleration variation that may be implemented based on the current state of the vehicle 100.

The acceleration correction unit 122a may set effective ranges of the acceleration and the acceleration variation. The effective range is a range in which ranges of an acceleration and an acceleration variation, which may actually occur, are specified based on the current state of the vehicle 100. The acceleration and acceleration variation due to external disturbance may cause a large change in the acceleration signal instantaneously and may be present outside the corresponding effective ranges. The effective ranges of the acceleration and the acceleration variation may be set, with values outside of the effective ranges may be processed as external disturbance, and thus the acceleration signal may be filtered.

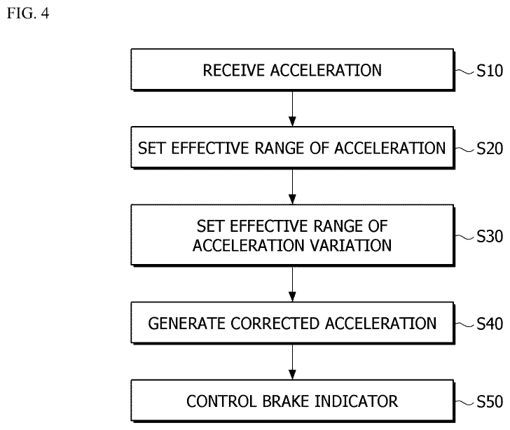

FIG. 4 is a flowchart illustrating a method of controlling a vehicle according to an embodiment.

Referring to FIG. 4, the method may include operation S10 of the sensor unit 104 receiving an acceleration signal, operations S20 and S30 of setting effective ranges of an acceleration and an acceleration variation, operation S40 of generating a corrected acceleration based on the effective ranges, and operation S50 of controlling the brake indicator 150 based on the corrected acceleration.

Since an acceleration signal includes the influence of external disturbance, it is desired to filter the influence of external disturbance. When the external disturbance occurs, the acceleration signal may be changed rapidly. For example, when the vehicle 100 goes over a bump or passes a pothole formed on the road surface, the vehicle 100 may instantaneously shake and the acceleration value of the vehicle 100 may be changed. In this case, the acceleration signal may reflect the changed acceleration value and may be changed significantly, and the acceleration value may instantaneously satisfy the operation reference of the brake indicator 150.

When the acceleration signal instantaneously satisfies the operation reference of the brake indicator 150, the brake indicator 150 may instantaneously operate. Since the brake indicator 150 includes the tail lights, a driver driving his or her vehicle behind the vehicle 100 may feel uncomfortable due to the flashing of the tail lights of the vehicle 100.

When external disturbance occurs, the value of the acceleration signal may be changed significantly, and thus the influence of the external disturbance may be distinguished based on the values of the acceleration and the acceleration variation. Accordingly, according to the present disclosure, the effective range of each of the acceleration and the acceleration variation is set, and it is determined that a signal outside the effective range is caused by external disturbance, and the signal is filtered.

The acceleration signal from which the influence of the external disturbance has been filtered corresponds to the corrected acceleration. According to the present disclosure, the corrected acceleration may be generated based on the effective ranges of the acceleration and the acceleration variation. The brake indicator 150 may be controlled based on the corrected acceleration. Since the influence of the external disturbance has been filtered, when the brake indicator 150 is controlled based on the corrected acceleration, the brake indicator 150 may accurately operate in response to the traveling state of the vehicle 100. In addition, it is possible to prevent unnecessary operation due to external disturbance.

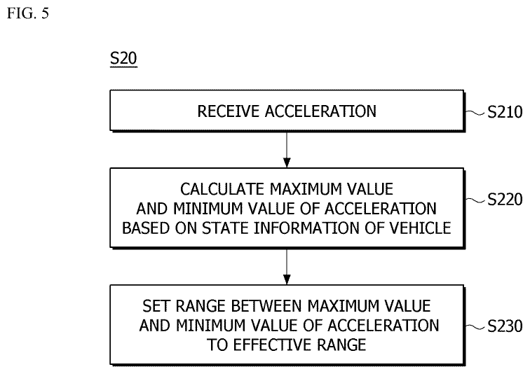

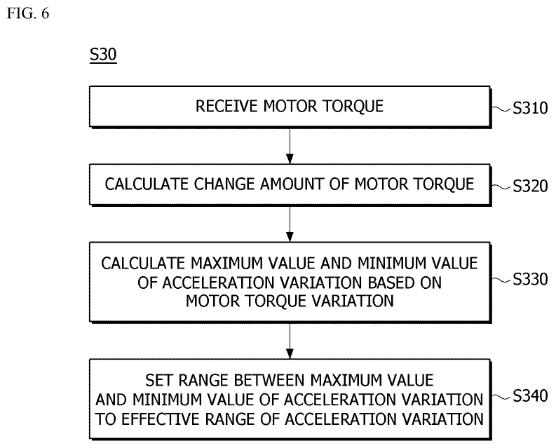

FIG. 5 is a flowchart illustrating a method of setting an effective range of an acceleration according to an embodiment. FIG. 6 is a flowchart illustrating a method of setting an effective range of an acceleration variation according to an embodiment.

According to the present disclosure, actual ranges of the acceleration and the acceleration variation of the vehicle 100 are estimated. The actual ranges of the acceleration and the acceleration variation may be determined based on the traveling state of the vehicle 100. The acceleration correction unit 122a may filter the acceleration signal based on each of the effective range of the acceleration and the effective range of the acceleration variation. In other words, the acceleration may be filtered twice.

The acceleration signal filtered by the effective range of the acceleration may be regarded as a primary corrected acceleration and the signal obtained by filtering the primary corrected acceleration by the effective range of the acceleration variation may be regarded as a secondary corrected acceleration.

Hereinafter, a method of setting an effective range of an acceleration is described with reference to FIG. 5.

The acceleration correction unit 122a may calculate maximum and minimum values of an acceleration. The maximum and minimum values of the acceleration define an effective range of the acceleration. The maximum and minimum values of the acceleration may be calculated based on the state information of the vehicle 100.

The sensor unit 104 may detect the acceleration of the vehicle 100. The sensor unit 104 may include an acceleration sensor, and the acceleration sensor may detect an acceleration by detecting the movement of the vehicle 100. As an example, the acceleration sensor may be provided in the ACU. Since the ACU controls the driving unit 140 of the vehicle 100, the ACU may detect an acceleration using a method of receiving a calculated acceleration from the ACU.

The acceleration correction unit 122a may calculate the maximum and minimum values of the acceleration. The maximum and minimum values of the acceleration may be determined based on the state information of the vehicle 100. The maximum and minimum values of the acceleration may be calculated by setting the range of acceleration values that may be actually derived based on the state information of the vehicle 100.

The state information of the vehicle 100 may include regenerative torque, a driving load, and braking torque. The regenerative torque corresponds to resistance due to the regenerative braking of the vehicle 100. The regenerative torque acts in a direction opposite to the traveling direction of the vehicle 100 and thus may affect the minimum value of the acceleration.

The regenerative torque may be estimated through a coast stage of a paddle lever for controlling the magnitude of the regenerative torque. The driver may manipulate the paddle lever to manipulate the coast stage of the regenerative torque. A preset regenerative torque may be operated based on the coast stage. As an example, when the user increases the coast stage by manipulating the paddle lever, the magnitude of the regenerative torque applied during regenerative braking may be increased. Conversely, when the user decreases the coast stage by manipulating the paddle lever, the magnitude of the regenerative torque applied during regenerative braking may be decreased.

The driving load corresponds to a load applied to the vehicle 100 when the vehicle 100 travels. The driving load may include a frictional force applied to the vehicle 100 when the vehicle 100 travels. As an example, the driving load may include a frictional force between wheels of the vehicle 100 and a road surface. When the vehicle 100 travels on the road surface, the frictional force is provided between the vehicle 100 and the road surface, and the vehicle 100 may travel without slipping.

The driving load may include air resistance applied when the vehicle 100 travels. When the vehicle 100 travels at a specific speed, air resistance based on a vehicle speed may be calculated. The air resistance is a factor generated without exception when the vehicle 100 travels and corresponds to the driving load, which may be calculated in response to a speed of the vehicle 100 and a cross-sectional area of the vehicle 100. However, it may be determined that the sudden air resistance, which may be generated while the vehicle 100 travels, i.e., resistance generated when strong wind blows suddenly or the like, means external disturbance. The air resistance included in the driving load is air resistance predicted based on the speed of the vehicle 100 in a general traveling situation.

The driving load may include a load caused by a gradient of a road surface on which the vehicle 100 is traveling. When the vehicle 100 travels on an inclined road, a gradient of the inclined road may affect the acceleration and deceleration of the vehicle 100. When the vehicle 100 travels on an uphill road, the vehicle 100 may receive a great driving load when compared to traveling on a flat road. In other words, resistance may be applied to the traveling of the vehicle 100.

Considering the above driving loads, the acceleration correction unit 122a may calculate the minimum value of the acceleration. Since the operation reference of the brake indicator 150 is not significantly related to the maximum value of the acceleration, the maximum value of the acceleration may be calculated more simply. Since a case in which the speed of the vehicle 100 increases is not related to an operation situation of the brake indicator 150, the calculation of the maximum value of the acceleration may be processed by simple calculation. The maximum value of the acceleration may be obtained by processing the acceleration signal using a method of simply filtering the acceleration signal having a preset reference value or more.

In the case of the minimum value of the acceleration, an area overlapping the operation situation of the brake indicator 150 may occur, and the minimum value of the acceleration needs to be calculated to include the operation reference of the brake indicator 150. Accordingly, the minimum value of the acceleration may be calculated to include the minimum value of the acceleration, which may actually be derived from the current state of the vehicle 100 considering the driving load as described above.

The driving load of the vehicle 100 may be detected through the sensor unit 104. In contrast, the driving load may be applied from the outside of the vehicle 100 to the vehicle 100. For example, the gradient of the road surface on which the vehicle 100 is traveling may be provided through road surface information transmitted from an external server of the vehicle 100. The transceiver may receive information about the road surface on which the vehicle 100 is traveling in communication with the server.

The braking torque is information corresponding a braking force of the brake unit 130. The braking torque may reflect the acceleration due to the brake. The braking force through the brake may be determined considering complex factors such as the speed of the vehicle 100, the weight of the vehicle 100, and the gradient of the road surface. The acceleration correction unit 122a may calculate a predicted braking torque through the brake based on the current state of the vehicle 100.

After collecting the state information of the vehicle 100 including the regenerative torque, the driving load, and the braking torque, the acceleration correction unit 122a calculates the minimum value of the acceleration based on the state information of the vehicle 100. A range between the maximum value of the acceleration and the minimum value of the acceleration may be set to an effective range of an acceleration. The effective range of the acceleration corresponds to a range of an acceleration, which may be derived based on the current state of the vehicle 100. It may be determined that values out of the effective range of the acceleration mean external disturbance, which cannot be derived by the vehicle 100. In other words, it may be determined that a detected acceleration signal greater than the maximum value of the acceleration or a detected acceleration signal smaller than the minimum value of the acceleration means external disturbance.

When the minimum value of the acceleration is calculated, a correction offset may be applied. The minimum value of the acceleration calculated based on the state information of the vehicle 100 corresponds to a theoretical minimum value of an acceleration based on the current state of the vehicle 100. To set the effective range of the actual acceleration, a predetermined offset may be applied to calculate an optimized value of the minimum value of the acceleration.

The acceleration correction unit 122a may compare the detected acceleration signal with the effective range of the acceleration. A signal outside the effective range of the acceleration may be filtered. As described above, since it is determined that the signal outside the range between the maximum and minimum values of the acceleration means external disturbance, the filtered acceleration signal corresponds to the primary corrected acceleration. The primary corrected acceleration may be additionally filtered by the acceleration correction unit 122a to generate the secondary corrected acceleration.

Hereinafter, a method of setting an effective range of an acceleration variation is described with reference to FIG. 6.

The acceleration correction unit 122a may calculate maximum and minimum values of an acceleration variation. The maximum and minimum values of the acceleration variation define the effective range of the acceleration variation. The maximum and minimum values of the acceleration variation may be calculated based on the state information of the vehicle 100.

In the case of the filtered acceleration signal within the effective range of the acceleration defined by the maximum and minimum values of the acceleration, even when the acceleration value falls within the effective range, the influence of external disturbance may be still present. In other words, it corresponds to a case in which the acceleration is changed by external disturbance but the acceleration value is changed within the effective range of the acceleration. Even in this case, there is a concern that the acceleration value is changed to instantaneously satisfy the operation reference of the brake indicator 150. Accordingly, the analysis of the acceleration variation is desired along with the acceleration value.

The acceleration variation indicates an acceleration variation over time. Accordingly, a signal of the acceleration variation may be obtained by differentiating the acceleration value detected by the acceleration sensor. The signal of the acceleration variation may be obtained by differentiating the acceleration signal detected by the sensor unit 104. Alternatively, the signal of the acceleration variation may be obtained by differentiating the primary corrected acceleration corrected by the effective range of the acceleration. The signal of the acceleration variation corresponds to a correction target of the acceleration correction unit 122a.

The maximum and minimum values of the acceleration variation may define a range of an acceleration variation, which may be derived based on the state information of the vehicle 100. The corresponding range is the effective range of the acceleration variation. The acceleration variation may correspond to the driving force of the vehicle 100. Accordingly, the acceleration variation may be determined based on motor torque of the vehicle 100. In other words, the state information of the vehicle 100 may include the motor torque. The motor torque is information corresponding to a current actual acceleration of the vehicle 100.

The sensor unit 104 may detect the motor torque of the vehicle 100. The motor torque of the vehicle 100 corresponds to torque provided by the motor of the driving unit 140. The motor torque value may be obtained by detecting the value of the motor torque. A motor torque variation may be obtained by differentiating motor torque over time. The motor torque corresponds to a parameter proportional to an acceleration. The maximum value of the acceleration variation may be calculated based on the motor torque variation.

The acceleration variation and the motor torque variation may correspond to information of an absolute value. In other words, the acceleration variation and the motor torque variation may have a positive sign. The variation does not correspond to a value that is directly compared to the operation reference of the brake indicator 150. In other words, since the size of the variation is an important factor, the acceleration variation and the motor torque variation may use the absolute value.

The motor torque is a value corresponding to actual torque of the traveling vehicle 100. In other words, the motor torque may provide actual state information of the vehicle 100, which is not affected by external disturbance. The sensor unit 104 may detect the motor torque and the motor torque variation and set the maximum value of the acceleration variation based on the motor torque variation. Since the motor torque variation is a value that is changed in real time based on the traveling of the vehicle 100, a maximum value of the motor torque variation and a maximum value of the acceleration variation accordingly may be updated in real time.

The state information of the vehicle 100 may include the desired torque variation. The desired torque corresponds to torque for providing an output based on the demand of a user as the user controls the vehicle 100. For example, when the user steps on the accelerator pedal, the desired torque may increase. In this case, the desired torque corresponds to a value greater than the motor torque corresponding to an actual driving force of the motor. The motor torque may increase until it is equal to the desired torque.

The desired torque may change depending on a traveling mode of the vehicle 100. As an example, when the traveling mode of the vehicle 100 is an eco/normal mode, the desired torque of the vehicle 100 may be set to be smaller than a preset reference value. When the traveling mode of the vehicle 100 is a sports/high-speed mode, the desired torque of the vehicle 100 may be set to be greater than the preset reference value. The reference value may correspond to a normal desired torque value of the vehicle 100. Maximum and minimum values of the motor torque variation may be determined by additionally reflecting the desired torque.

The change in acceleration due to external disturbance corresponds to a range in which the acceleration signal is changed rapidly. The change in acceleration due to regenerative braking or a driver's manipulation of the brake unit 130 occurs for a relatively long time, and the acceleration variation may also be maintained at a constant level. However, the change in acceleration due to external disturbance may occur in a large range for a short time. It is because when external disturbance occurs, the movement and arrangement of the vehicle 100 may be affected instantaneously. The acceleration signal due to regenerative braking or the brake unit 130 may correspond to a low-frequency signal, and the acceleration signal due to external disturbance may correspond to a high-frequency signal.

The acceleration correction unit 122a may collect the signal of the acceleration variation based on the acceleration signal detected by the sensor unit 104 and then compares the signal with the effective range of the acceleration variation, which is defined by the maximum and minimum values of the acceleration variation. It may be determined that values among the signals of the acceleration variation, which are present outside the effective range of the acceleration variation, are caused by external disturbance.

The acceleration correction unit 122a may generate a secondary corrected acceleration by filtering the values outside the effective range of the acceleration variation based on the signal of the acceleration variation. The secondary corrected acceleration is acceleration that corrects the acceleration signal detected by the sensor unit 104 or the signal of the acceleration variation that differentiates the primary corrected acceleration. When the signal of the acceleration variation, which differentiates the primary corrected acceleration is used, a corrected acceleration, which reflects the correction by both the effective range of the acceleration and the effective range of the acceleration variation, may be generated.

When the signal of the acceleration variation, which differentiates the acceleration signal detected by the sensor unit 104, is used, the secondary corrected acceleration corresponds to a corrected acceleration that reflects the correction by the effective range of the acceleration variation. In this case, a process of matching the primary corrected acceleration with the secondary corrected acceleration may be performed. The corresponding process is a process for generating a corrected acceleration, which reflects both a portion corrected by an effective range of an acceleration and a portion corrected by an effective range of an acceleration variation.

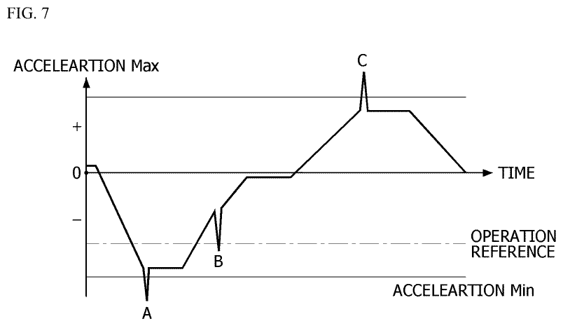

FIG. 7 illustrates setting of the effective range of an acceleration according to an embodiment.

Referring to FIG. 7, a graph visually illustrating the effective range of an acceleration may be shown. The graph illustrated in FIG. 7 is an acceleration signal representing an acceleration value over time. The signal corresponds to the acceleration signal detected by the sensor unit 104. In other words, the signal is an acceleration signal, which reflects the influence of external disturbance.

The acceleration correction unit 122a may set the effective range of the acceleration defined by the maximum and minimum values of the acceleration. The minimum value of the acceleration may be set to be smaller than a lighting reference of the brake indicator 150. Points A and C outside the corresponding effective range may be determined to be affected by external disturbance and may be corrected.

Point B in FIG. 7 has an acceleration value within the effective range of the acceleration. Accordingly, even when correction is performed through the effective range of the acceleration, the corresponding portion may not be corrected. Since an acceleration value at point B is a value that may temporarily satisfy the operation reference of the brake indicator 150, the unnecessary operation of the brake indicator 150 may occur.

Point B may be corrected based on the correction by the effective range of the acceleration variation. Point B corresponds to a part in which the acceleration value is instantaneously changed significantly and thus includes a value of the acceleration variation that cannot be derived from the current state of the vehicle 100. Accordingly, the acceleration variation at point B corresponds to a value outside the effective range of the acceleration variation. The acceleration correction unit 122a may determine that point B is due to external disturbance and correct point B during the process of generating a corrected acceleration through the effective range of the acceleration variation.

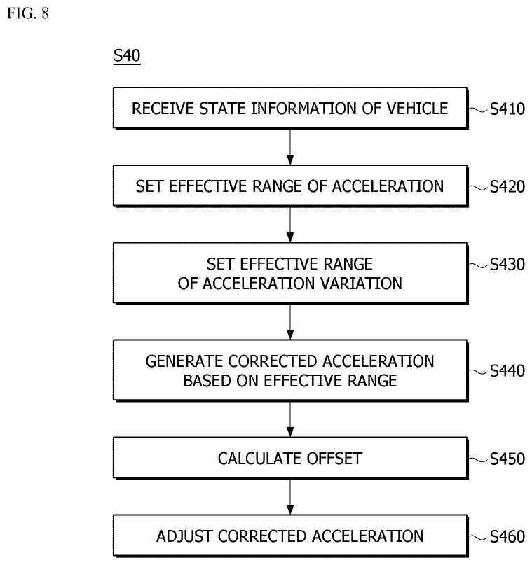

FIG. 8 is a flowchart illustrating an order of generating a corrected acceleration according to an embodiment.

Referring to FIG. 8, operation S40 may include: operation S410 of receiving state information of the vehicle 100; operation S420 of setting effective range of acceleration; operation S430 of setting effective range of acceleration variation; operation S440 of generating corrected acceleration based on effective range; operation S450 of calculating offset; and operation S460 of adjusting corrected acceleration.

Referring to FIG. 8, the acceleration correction unit 122a may calculate an offset based on a delay time and adjust the corrected acceleration based on the offset. The acceleration correction unit 122a may calculate the offset and then reflect the offset in the generated corrected acceleration to adjust the corrected acceleration.

The offset may be calculated based on the delay time. The delay time may include a sensing delay time generated in the sensor unit 104 and a calculation delay time of the acceleration correction unit 122a. The acceleration signal needs to be processed to be advanced by the delay time. When the delay time increases, the corrected acceleration may be identified with a predetermined time difference compared to the actual acceleration of the vehicle 100.

When the corrected acceleration is identified with a time difference from the actual acceleration, there is a concern that the vehicle 100 operates after a time difference even when the acceleration of the vehicle 100 satisfies the preset operation reference of the brake indicator 150. The corrected acceleration may be adjusted considering the offset reflecting the delay time for immediate operation of the brake indicator 150.

Based on the effective range of the acceleration and the effective range of the acceleration variation, the corrected acceleration that has filtered the influence of external disturbance present in the acceleration signal may be generated. Then the offset may be reflected to adjust the corrected acceleration corresponding to the input for operating the brake indicator 150.

When the corrected accelerations generated based on the effective range of the acceleration and the effective range of the acceleration variation are referred to as the primary corrected acceleration and the secondary corrected acceleration, respectively, the acceleration correction unit 122a may be regarded as generating a final corrected acceleration by applying the offset to the secondary corrected acceleration.

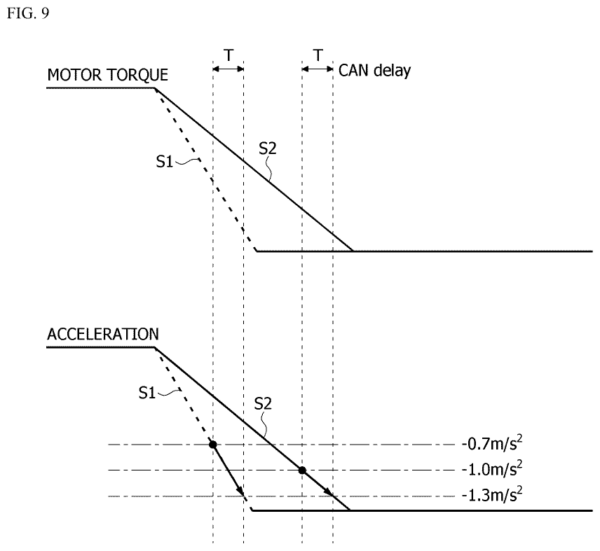

FIG. 9 illustrates that an offset is calculated based on torque variation and acceleration according to an embodiment.

The offset value may be proportional to the motor torque variation. The motor torque is information corresponding to an actual acceleration of the vehicle 100. Accordingly, the motor torque variation may correspond to an actual acceleration variation. When the motor torque variation is large, an acceleration variation may also increase proportionally. When the acceleration variation increases, an error in acceleration may increase even when the size of the offset based on the time delay is the same.

FIG. 9 is a graph illustrating values of motor torque and acceleration over time. The motor torque and the acceleration are each divided into cases in which variation (gradient) is S1 and S2. The gradient has a greater value in the case of S1 than in the case of S2, which means that the motor torque variation and the amount of the acceleration over time are large.

In both cases, it is assumed that the offset based on the time delay is T. During the same offset interval T, when the gradient is S1, acceleration is changed from −0.7 m/s² to −1.3 m/s². When the gradient is S2, the acceleration is changed from −1.0 m/s² to −1.3 m/s².

As described above, when the change in motor torque is great, the acceleration variation also increases. In other words, the acceleration changes more quickly and the time for the acceleration to reach a specific value can be shortened. In this case, it is necessary to further advance the corrected acceleration signal by reflecting this in the offset. When the motor torque is relatively small, the acceleration variation also decreases proportionally. A changing speed of the acceleration may slow down and the time it takes for the acceleration to reach the specific value may increase.

By detecting the motor torque variation in real time, an offset for adjusting the corrected acceleration may be set in real time. When the motor torque variation increases, the offset also increases proportionally, and when the motor torque variation decreases, the offset also decreases proportionally.

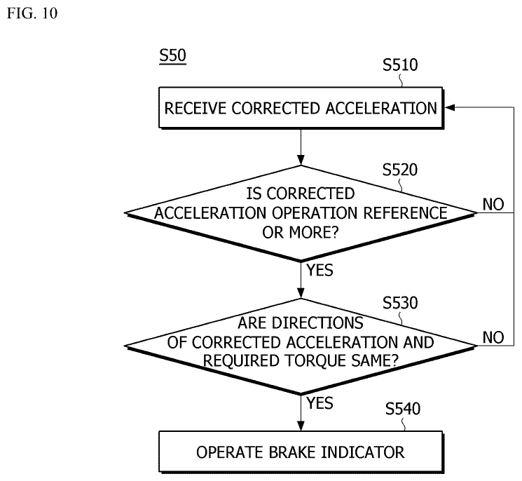

FIG. 10 is a flowchart illustrating a method of operating the brake indicator 150 based on the corrected acceleration according to an embodiment.

After the corrected acceleration is generated by the acceleration correction unit 122a, the control unit 122b may control the brake indicator 150 to operate based on the corrected acceleration. The brake indicator 150 may include a component such as brake lights. The control unit 122b may operate the brake indicator 150 when the corrected acceleration satisfies the preset operation reference of the brake indicator 150.

As an example, the brake light may be turned on when the deceleration of the vehicle 100 is greater than a preset reference. The preset reference may be 1.3 m/s². In this case, the brake light is turned on when the deceleration of the vehicle 100 is more than 1.3 m/s².

The control unit 122b according to the present embodiment receives the corrected acceleration value and determines whether the corrected acceleration is greater than or equal to the preset operation reference. When the corrected acceleration is smaller than the operation reference, the corrected acceleration may be continuously received.

When it is determined that the corrected acceleration is greater than or equal to the operation reference, whether directions of the corrected acceleration and the desired torque are the same may be determined. Even when the corrected acceleration is greater than or equal to the operation reference, the corrected acceleration may correspond to an acceleration temporarily generated by external disturbance or the like. In this case, the direction of the desired torque and the direction of the corrected acceleration of the vehicle 100 may be compared.

The desired torque means the magnitude of the torque desired in response to the manipulation of the user. For example, when the user wants to accelerate the vehicle 100 forward, the user may step on the accelerator pedal, and the desired torque may have a positive value. When the user wants to decelerate the vehicle 100, the user may step off the accelerator pedal or operate the brake, and the desired torque may have a negative value.

The direction of the desired torque and the direction of the corrected acceleration may be compared, and when the direction of the corrected acceleration is the same as the direction of the desired torque, the brake indicator 150 may be operated. When the direction of the corrected acceleration corresponds to the direction for deceleration of the vehicle 100 and the direction of the desired torque corresponds to the direction for deceleration of the vehicle 100, it may be determined that the current vehicle 100 is decelerating, and it may be determined that the operation of the brake indicator 150 is desired.

When the direction of the desired torque corresponds to the direction of increasing speed of the vehicle 100 and the direction of the corrected acceleration corresponds to the direction of deceleration, it may be determined that the value of the corrected acceleration is a value that appears temporarily. In other words, since the corrected acceleration value can be regarded as being temporarily generated to be the operation reference value or more of the brake indicator 150 due to external disturbance or the like, the operation of the brake indicator 150 can be prevented.

Even when the corrected acceleration satisfies the operation reference of the brake indicator 150, the control unit 122b can secondarily prevent a malfunction of the brake indicator 150 through comparison with the desired torque.

Hereinafter, a control method of the vehicle 100 according to the embodiment of the present disclosure is described.

FIG. 4 corresponds to a schematic flowchart illustrating the control method. The control method may include operation S10 of receiving an acceleration of the vehicle 100, operation S20 of setting an effective range of the acceleration, operation S30 of setting an effective range of an acceleration variation, operation S40 of generating a corrected acceleration within the effective range, and operation S50 of controlling a brake indicator 150 based on the corrected acceleration value.

As illustrated in FIG. 5, operation S20 of setting effective range of the acceleration may include operation S210 of receiving state information of the vehicle 100, and operation S220 of calculating maximum and minimum values of the acceleration based on the state information of the vehicle 100. The effective range of the acceleration may be defined by the maximum and minimum values of the acceleration. The state information of the vehicle 100 may include regenerative torque, driving load, and braking torque of the vehicle 100. Operation S20 of setting effective range of the acceleration may also include operation S230 of setting the range between the maximum value and the minimum value of acceleration to the effective range.

As illustrated in FIG. 6, operation S30 of setting effective range of the acceleration variation may include operation S310 of receiving motor torque, operation S320 of differentiating motor torque to calculate a motor torque variation, and operation S330 of calculating maximum and minimum values of the acceleration variation. The acceleration variation may be calculated based on the motor torque variation. An effective range of acceleration variation may be defined by the maximum and minimum values of the acceleration variation. Operation S30 of setting effective range of the acceleration variation may also include operation S340 of setting the range between the maximum value and the minimum value of acceleration variation to effective range of acceleration variation.

When the effective range of the acceleration and the effective range of the acceleration variation are calculated, the acceleration signal may be filtered based on the effective range of the acceleration and the effective range of the acceleration variation, and a corrected acceleration may be generated. An acceleration signal may be sequentially filtered based on the effective range of the acceleration and the effective range of the acceleration variation.

Accordingly, the control method may include the operation of generating a primary corrected acceleration based on the effective range of the acceleration after operation S20 of setting effective range of the acceleration. Likewise, the control method may include the operation of generating a secondary corrected acceleration based on the effective range of the acceleration variation after operation S30 of setting effective range of the acceleration variation.

According to one embodiment of the present disclosure, the control method may further include operation S450 of calculating an offset based on a delay time after operation S40 of generating a corrected acceleration. The offset may be calculated to be proportional to the motor torque variation. The control method may include operation S460 of adjusting a corrected acceleration based on the offset after operation S450 of calculating an offset.

When the corrected acceleration generated based on the effective range of the acceleration variation is referred to as the secondary corrected acceleration, the control method may include operation S450 of calculating an offset and operation S460 of generating a final corrected acceleration based on the offset after the operation of generating a secondary corrected acceleration.

Referring to FIG. 10, operation S50 of controlling the brake indicator 150 based on the corrected acceleration value may further include: operation S510 of receiving corrected acceleration; S520 of comparing the operation reference of the brake indicator 150 with the corrected acceleration value; and operation S530 of comparing the corrected acceleration value with the desired torque. Operation S530 of comparing the corrected acceleration value with the desired torque is an operation of comparing a direction of the corrected acceleration with a direction of the desired torque. When the direction of the corrected acceleration and the direction of the desired torque are the same, operation S540 of operating the brake indicator 150 may be performed.

Although the above methods of the present disclosure are represented as a series of operations for the sake of clarity of description, it is not intended to limit the execution order of the operation, and each operation may be performed simultaneously or in a different order as needed. To implement the method according to the present disclosure, additional operations may be included in the operations, or some operations may be performed and the remaining operations may be included, or some operations may be excluded and additional other operations may be included.

Various embodiments of the present disclosure do not list all possible combinations but are intended to describe representative aspects of the present disclosure, and the matters described in the various embodiments may be applied independently or in combination of two or more.

In addition, various embodiments of the present disclosure may be implemented by hardware, firmware, software, or a combination thereof. When various embodiments are implemented by hardware, various embodiments may be implemented by one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, or the like.

The scope of the present disclosure includes software or machine-executable instructions (e.g., an operating system, an application, firmware, a program, and the like), which cause operations according to methods of various embodiments to be executed on a device or a computer, and a non-transitory computer-readable medium in which such software or instructions are stored and is executable on the device or the computer.

According to embodiments of the present disclosure, it is possible to set effective ranges that are ranges of an acceleration and an acceleration variation that can be derived based on state information of a vehicle and filter an acceleration signal within the effective ranges to generate a corrected acceleration. As a result, the influence of external disturbance is removed. Accordingly, it is not necessary to separately set an acceleration signal processing method based on a state of the vehicle, and it is possible to improve reliability of the generated corrected acceleration.

Effects of the present disclosure are not limited to the above-described effects, and other effects that are not described should become apparent to those having ordinary skill in the art from the following description.

What is claimed is:

1. A vehicle comprising:
a brake indicator;
a sensor unit configured to detect state information of the vehicle and an acceleration signal of the vehicle;
an acceleration correction unit configured to generate a corrected acceleration from the acceleration signal of the vehicle; and
a control unit configured to control the brake indicator based on a value of the corrected acceleration,
wherein the acceleration correction unit sets effective ranges of an acceleration and an acceleration variation of the vehicle, and generates the corrected acceleration within the effective ranges.

2. The vehicle of claim 1, wherein the acceleration correction unit calculates a maximum value of the acceleration and a minimum value of the acceleration, defining the effective range of the acceleration, and
wherein the minimum value of the acceleration is calculated based on the state information of the vehicle.

3. The vehicle of claim 2, wherein the state information of the vehicle comprises a regenerative torque, a driving load, and a braking torque.

4. The vehicle of claim 1, wherein the acceleration correction unit calculates a maximum value of the acceleration variation and a minimum value of the acceleration variation, defining the effective range of the acceleration variation.

5. The vehicle of claim 4, wherein the sensor unit detects a motor torque of the vehicle, and
wherein the maximum value of the acceleration variation and the minimum value of the acceleration variation are calculated by differentiating the motor torque.

6. The vehicle of claim 5, wherein the acceleration correction unit calculates a delay time comprising a sensing delay time generated by the sensor unit and a calculation delay time of the acceleration correction unit and calculates an offset for adjusting the corrected acceleration in response to the delay time, and
wherein the offset is proportional to a differential value of the motor torque.

7. The vehicle of claim 3, wherein the control unit operates the brake indicator when the value of the corrected acceleration is a preset operation reference or more.

8. The vehicle of claim 7, wherein the sensor unit detects a desired torque of the vehicle, and
wherein the control unit operates the brake indicator when the value of the corrected acceleration is the preset operation reference or more and a direction of the desired torque and a direction of the corrected acceleration are the same.

9. The vehicle of claim 1, wherein the sensor unit comprises an outward-facing camera, a Light Detection and Ranging (LiDAR) sensor, a radar sensor, a positioning sensor, a wheel sensor, and an attitude sensor.

10. The vehicle of claim 1, wherein the corrected acceleration is a signal from which influence of external disturbance is removed from the acceleration signal of the vehicle.

11. The vehicle of claim 1, wherein the acceleration correction unit is further configured to filter the acceleration signal based on each of the effective range of the acceleration and the effective range of the acceleration variation.

12. A control method comprising:
receiving an acceleration of a vehicle;
setting an effective range of the acceleration of the vehicle;
setting an effective range of an acceleration variation of the vehicle;
generating a corrected acceleration within the effective ranges; and
controlling a brake indicator based on a value of the corrected acceleration.

13. The control method of claim 12, wherein the setting of the effective range of the acceleration of the vehicle comprises:
receiving state information of the vehicle; and
calculating a maximum value and a minimum value of the acceleration based on the state information of the vehicle.

14. The control method of claim 13, wherein the state information of the vehicle comprises a regenerative torque, a driving load, and a braking torque of the vehicle.

15. The control method of claim 12, wherein the setting of the effective range of the acceleration variation comprises:
receiving a motor torque of the vehicle;
differentiating the motor torque to calculate a motor torque variation; and
calculating a maximum value and a minimum value of the acceleration variation.

16. The control method of claim 12, further comprising:
calculating an offset based on a delay time after setting the effective range of the acceleration variation,
wherein the offset is proportional to a motor torque variation.

17. The control method of claim 12, wherein the controlling of the brake indicator based on the value of the corrected acceleration comprises comparing an operation reference of the brake indicator with the value of the corrected acceleration.

18. The control method of claim 17, wherein the controlling of the brake indicator based on the value of the corrected acceleration further comprises comparing the value of the corrected acceleration with a desired torque,
wherein the brake indicator is operated when directions of the value of the corrected acceleration and the desired torque are the same.

19. The control method of claim 12, further comprising:
receiving an acceleration signal of the vehicle,
wherein the corrected acceleration is a signal from which influence of external disturbance is removed from the acceleration signal of the vehicle.

20. The control method of claim 19, wherein generating the corrected acceleration within the effective ranges comprises:
filtering the acceleration signal based on each of the effective range of the acceleration and the effective range of the acceleration variation.
